(19) United States
(12) Patent Application Publication
(10) Pub. No.: US 2024/0419206 A1
(43) Pub. Date: Dec. 19, 2024

(54) ANALOG INTEGRATOR INCORPORATING OPTO-ISOLATORS

(71) Applicants: Dmitri Pescianschi, Quedlinburg (DE); llya Sorokin, Naples, FL (US)

(72) Inventors: Dmitri Pescianschi, Quedlinburg (DE); llya Sorokin, Naples, FL (US)

(21) Appl. No.: 18/744,618

(22) Filed: Jun. 15, 2024

Related U.S. Application Data
(60) Provisional application No. 63/521,421, filed on Jun. 16, 2023.
(60) Provisional application No. 63/521,468, filed on Jun. 16, 2023.

(51) Int. Cl. G06E 3/00; G02F 1/09

(52) U.S. Cl. CPC G06E 3/005; G02F 1/093

(57) ABSTRACT

An apparatus for analog numerical integration having multiple opto-isolators each with an additional level of signal modulation. The opto-isolators are connected in series or in parallel, so as to sum up output signals from all connected opto-isolators. Each opto-isolator has a light emitter, at least one light guide, a light recorder optically connected to the light emitter via the light guide, and an optical signal modulator optically connected to the light emitter, the light guide or the light recorder. The optical signal modulator modulates an optical signal within each opto-isolator.

### CROSS-REFERENCE TO RELATED APPLICATIONS

This application claims all rights of priority to U.S. Provisional Patent Applications Nos. 63/521,421 and 63/521,468, both filed on Jun. 16, 2023 (pending).

### BACKGROUND

The invention relates to the field of electronics, microelectronics, optoelectronics, information processing and conversion.

An analog integrator circuit is a fundamental building block of analog computers that outputs the integral of an input signal over a frequency range. The circuit's time constant and amplifier bandwidth determine the frequency range. The output voltage is dependent on the input current's value and the feedback capacitor's inverse value.

An opto-isolator (also known as an optical coupler, photocoupler, optocoupler) is a semiconductor device that transfers an electrical signal between isolated circuits using light. These electronic components are used in a wide variety of communications and monitoring systems that use electrical isolation to prevent high voltage emitters from affecting lower power circuitry receiving a signal.

### SUMMARY

In its most general aspect, the invention is an apparatus for analog numerical integration having multiple opto-isolators each with an additional level of signal modulation. The opto-isolators are connected in series or in parallel, so as to sum up output signals from all connected opto-isolators. Each opto-isolator has a light emitter, at least one light guide, a light recorder optically connected to the light emitter via the light guide, and an optical signal modulator optically connected to the light emitter, the light guide or the light recorder. The optical signal modulator modulates an optical signal within each opto-isolator.

### BRIEF DESCRIPTION OF THE DRAWINGS

The invention is illustrated by way of examples which are not a limitation, and the figures of the accompanying drawings in which references denote corresponding parts, and in which:

FIG. 1 shows a schematic diagram of an opto-isolator with an optical modulator;

FIG. 2 shows a schematic diagram of an opto-isolator with optical memory;

FIG. 3 shows a schematic diagram of an opto-isolator with an emitter modulator;

FIG. 4 shows a schematic diagram of an opto-isolator with an emitter modulator and memory;

FIG. 5 shows a schematic diagram of an opto-isolator with a recorder modulator; and

FIG. 6 shows a schematic diagram of an opto-isolator with a recorder modulator and memory.

### DETAILED DESCRIPTION OF THE INVENTION

The main concept of most methods of numerical integration is to replace the integrand function with a simpler one, the integral of which is easily calculated analytically. In this case, to estimate the value of the integral, the following formula is utilized:

$$I \approx {\sum }_{i = 1}^{n} {ω}_{i} f ( {x}_{i} )$$

where n is the number of points at which the value of the integrand function is calculated. The points xᵢ are called nodes of the method, the numbers ωᵢ are node weights.

Opto-isolators with an additional level of controlled optical signal modulators are a suitable tool for calculating an individual operation ωᵢf(xᵢ).

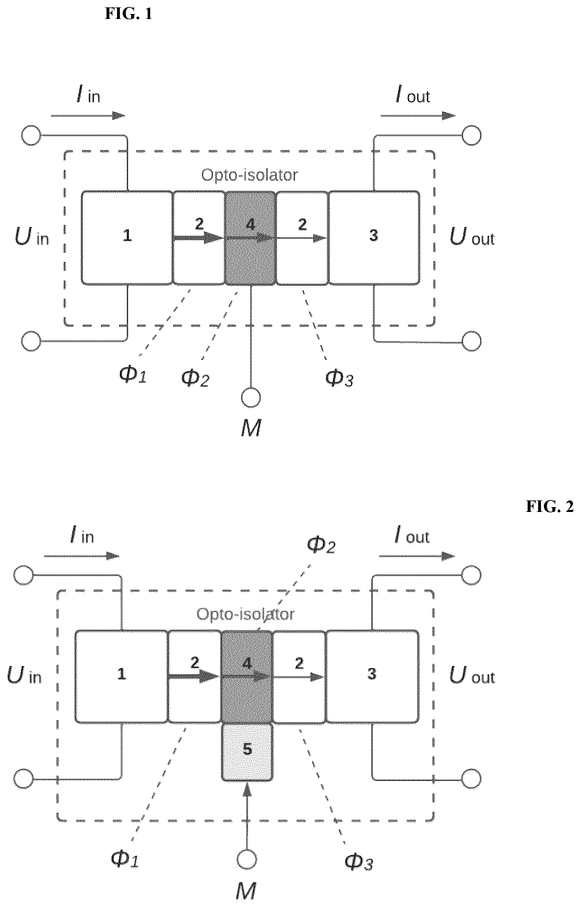

All types of opto-isolators with an additional level of controlled optical signal modulators are suitable for such an operation. As shown in FIG. 1, in its first preferred embodiment, the invention includes an opto-isolator with an optical modulator, preferably comprising a light emitter 1, light guides 2, a light recorder 3, and a controlled optical modulator 4. The light emitter 1 is connected to the first light guide 2. The second light guide 2 is connected to the light recorder 3. The controlled optical modulator 4 is positioned between the first and second light guides 2 and is configured to receive a modulator control signal M. Uᵢₙ is the input voltage of the optocoupler and Iᵢₙ is the input current of the optocoupler. Uₒᵤₜ is the output voltage of the optocoupler and Iₒᵤₜ is the output current of the optocoupler. ϕ₁ designates a generated luminous flux, ϕ₂ designates a modifiable luminous flux; and ϕ₃ designates a modulated luminous flux.

Another preferred embodiment of the present invention is illustrated in FIG. 2 which shows an opto-isolator with an optical memory. In this embodiment the opto-isolator preferably comprises the light emitter 1, light guides 2, the light recorder 3, a memory-controlled optical modulator 4 and an optical modulator memory 5. Similarly to the first preferred embodiment, the light emitter 1 is connected to the first light guide 2, and the second light guide 2 is connected to the light recorder 3. The controlled optical modulator 4 is positioned between the first and second light guides 2 and is also connected to the optical modulator memory 5, which is configured to receive the modulator memory recording signal M. Uᵢₙ is the input voltage of the optocoupler, and Iᵢₙ is the input current of the optocoupler. Uₒᵤₜ is the output voltage of the optocoupler, and Iₒᵤₜ is the output current of the optocoupler. ϕ₁ is the generated luminous flux, ϕ₂ is the modifiable luminous flux, and ϕ₃ is the modulated luminous flux. When using opto-isolators with memory, the level of optical modulation of the signal is preferably stored in the memory 5 of the modulator.

Any device that allows for arbitrary modulation of the luminous flux can be utilized in the present invention as the controlled optical modulator. For example, liquid crystals, Mach-Zehnder interferometers, diarylethene molecules and/or crystals, ring optical resonators, or modulators based on the magneto-optical Kerr effect can all be used as controlled optical modulators 4 of the present invention. Further, any controlled physical effect that changes the optical properties of the medium (light guide) can be used in the controlled optical modulator.

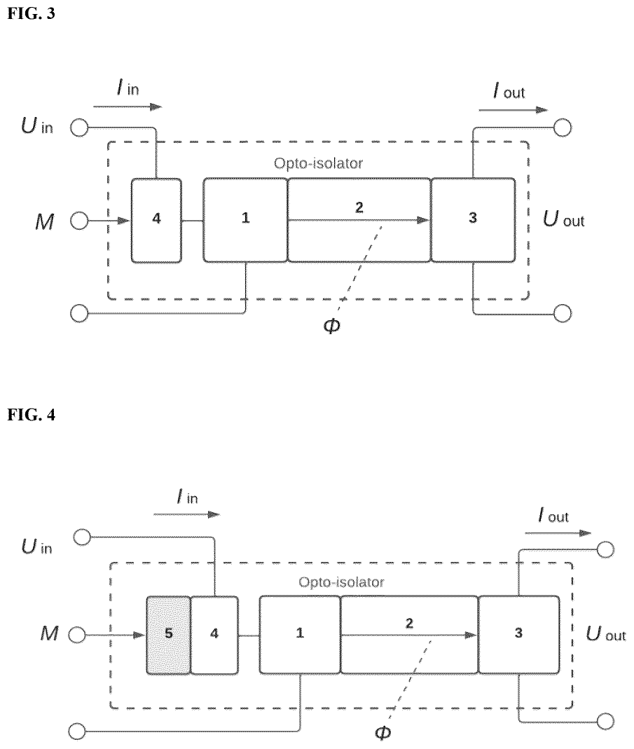

FIG. 3 shows another embodiment of the opto-isolator of the present invention, in which the opto-isolator is equipped with an emitter modulator. In this embodiment, the opto-isolator comprises the light emitter 1 with a connected modulator 4 controlling the brightness of the light emitter, the light recorder 3 and the light guide 2 positioned between the light emitter 1 and the light recorder 3. In this embodiment, the modulator control signal M is supplied to the modulator 4 to control the brightness of the light emitter 1. Similarly to the above, Uᵢₙ is the input voltage of the optocoupler, Iᵢₙ is the input current of the optocoupler, Uₒᵤₜ is the output voltage of the optocoupler, Iₒᵤₜ is the output current of the optocoupler, and ϕ is the luminous flux.

FIG. 4 shows an embodiment of the opto-isolator similar to the embodiment shown in FIG. 3, where the opto-isolator is further equipped with a transmitter modulator memory. In this embodiment, the opto-isolator comprises the light emitter 1 with connected transmitter brightness modulator memory 5 and modulator 4 controlling the brightness of the light emitter. The opto-isolator also comprises the light recorder 3 and the light guide 2 positioned between the light emitter 1 and the light recorder 3. The modulator control signal M is supplied to the transmitter brightness modulator memory 5 to control the brightness of the light emitter 1 through the modulator 4. Similarly to the above, Uᵢₙ is the input voltage of the optocoupler, Iᵢₙ is the input current of the optocoupler, Uₒᵤₜ is the output voltage of the optocoupler, Iₒᵤₜ is the output current of the optocoupler, and ϕ is the luminous flux.

In the embodiments shown in FIGS. 3 and 4, the controlled modulator 4 can be any device that allows for an arbitrary modulation of the voltage or current controlling the brightness of the emitter 1. Such a device may be, for example, a transistor, e.g., a field-effect transistor, a memristor whose control resistance is modulated by a pre-fed correction voltage, a digital-to-analog converter (DAC) or an operational amplifier. Any controlled physical effect or device that changes the intensity of the radiation on the transmitter can be used as a controlled additional modulator of the transmitter.

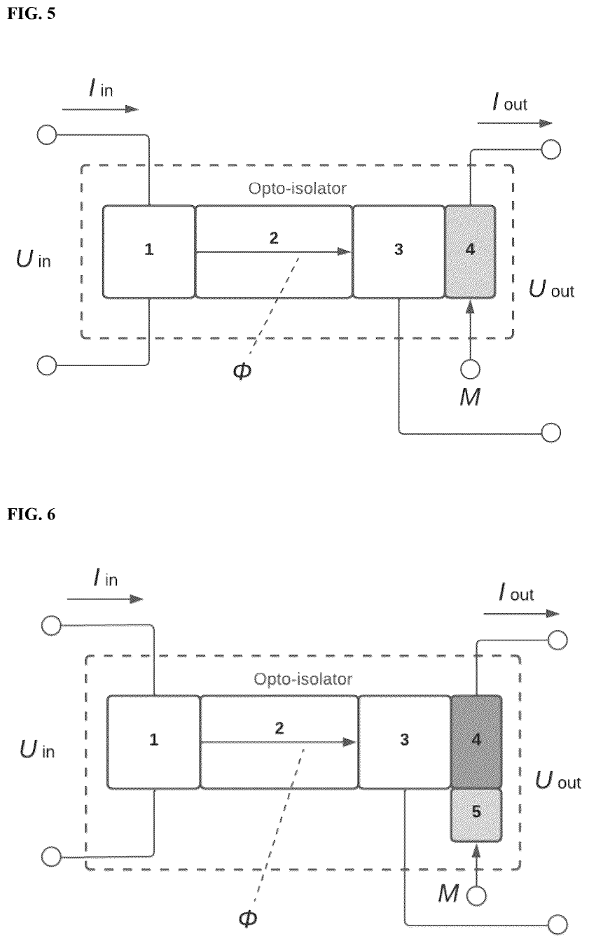

FIG. 5 shows another embodiment of the opto-isolator of the present invention where the opto-isolator includes an additional signal output modulation level. In the embodiment, the opto-isolator circuit preferably includes the light emitter 1, the light recorder 3 and the light guide 2 positioned between the light emitter 1 and the light recorder 3. The controlled electronic modulator 4, in this embodiment, is connected to the light recorder 3 to accomplish the additional level of output electronic signal modulation. Accordingly, the modulator control signal M is applied to the modulator 4 to modulate the recorder output signal. Once again, Uᵢₙ is the input voltage of the optocoupler, Iᵢₙ is the input current of the optocoupler, Uₒᵤₜ is the output voltage of the optocoupler, Iₒᵤₜ is the output current of the optocoupler, and ϕ is the luminous flux.

FIG. 6 shows an embodiment of the opto-isolator similar to the embodiment shown in FIG. 5, where the opto-isolator with output signal modulation is further provided with a modulator memory. In this embodiment, the opto-isolator preferably comprises the light emitter 1, the light recorder 3 and the light guide 2 positioned between the light emitter 1 and the light recorder 3. The recorder modulator memory 5 is connected to the controlled electronic modulator 4, which, in turn, is connected to the light recorder 3 to accomplish the additional level of output electronic signal modulation. The modulator control signal M is applied to the modulator 4 through the recorder modulator memory 5 to modulate the recorder output signal. Again, Uᵢₙ is the input voltage of the optocoupler, Iᵢₙ is the input current of the optocoupler, Uₒᵤₜ is the output voltage of the optocoupler, Iₒᵤₜ is the output current of the optocoupler, and ϕ is the luminous flux.

In the embodiments shown in FIGS. 5 and 6, the controlled modulator 4 can be any device that allows for an arbitrary modulation of the voltage or current that controls the output signal of the recorder 3. For example, transistors, such as field-effect transistors, memristors whose control resistance is modulated by a pre-fed correction voltage, digital-to-analog converters (DAC) or operational amplifiers can be used as controlled modulators 4. Any controlled physical effect or device that changes the intensity of an electronic signal can be used as a controlled additional emitter modulator. When using the opto-isolator with memory 5, the modulation level of the output signal recorder (e.g., a radiation logger) 3 is preferably stored in the modulator memory 5.

When using any of the described opto-isolators with an additional level of modulation of the optical signal, the input signal, which can be represented as f(xᵢ), is weighted by an additional optical or electrical modulator whose weighting factor can be represented as di. Thus, this type of opto-isolators with an additional modulation level of the optical signal will perform the weighting operation ωᵢf(x_{I}).

The modulated optical signal in the opto-isolator enters the light recorder, which captures the result of signal weighting. The connection of multiple opto-isolators allows to perform analog summation of weighted signals, i.e. to make numerical integration

$$I \approx {\sum }_{i = 1}^{n} {ω}_{i} f ( {x}_{i} )$$

To assemble the apparatus for analog numerical integration, a plurality of opto-isolators, each provided with the additional controlled modulation of the optical signal, as described above, are connected in series or in parallel, so as to sum up output signals from all connected opto-isolators. Where the opto-isolators are connected in series, the apparatus performs integration by summing up voltages generated by the connected opto-isolators. When the opto-isolators are connected in parallel, the apparatus performs integration by summing up currents generated by the connected opto-isolators. When the opto-isolators are resistive opto-isolators which are connected in series, the apparatus performs integration by measuring a total electrical resistance of the series-connected resistive opto-isolators. When the opto-isolators are capacitive opto-isolators which are connected in parallel, the apparatus performs integration by summing up capacitances of these capacitive opto-isolators connected in parallel. Finally, where, at each opto-isolator in the system, the light guides are connected into a common light guide with one common light recorder at the output, the weighted light signals from all opto-isolators, coded by the intensity of the light flux, are merged, and therefore summed, in the common light guide.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

We claim as follows:

1. An opto-isolator comprising:
a light emitter;
at least one light guide;
a light recorder optically connected to said light emitter via said light guide; and
an optical signal modulator optically connected to at least one of said light emitter, said light guide and said light recorder, said optical signal modulator being configured to modulate an optical signal within said opto-isolator.

2. The opto-isolator according to claim 1, further comprising a memory device connected to said optical signal modulator, said memory device being configured to record a level of modulation of said optical signal.

3. The opto-isolator according to claim 1, wherein when said optical signal modulator is optically connected to said light emitter, said optical signal modulator is configured to modulate brightness of said light emitter.

4. The opto-isolator according to claim 1, wherein when said optical signal modulator is optically connected to said light guide, said optical signal modulator is configured to modulate a luminous flux within said light guide.

5. The opto-isolator according to claim 1, wherein when said optical signal modulator is optically connected to said light recorder, said optical signal modulator is configured to modulate an optical output signal of said light recorder.

6. The opto-isolator according to claim 1, wherein said light recorder is configured to convert a weighted optical signal into an electrical signal.

7. An apparatus for analog numerical integration comprising:
a plurality of opto-isolators, each opto-isolator having a light emitter, at least one light guide,
a light recorder optically connected to said light emitter via said light guide, and an optical signal modulator optically connected to at least one of said light emitter, said light guide and said light recorder, said optical signal modulator being configured to modulate an optical signal within said opto-isolator,
wherein said opto-isolators are connected in series or in parallel, so as to sum up output signals from all connected opto-isolators.

8. The apparatus of claim 7, wherein each of said light recorders of said opto-isolators is configured to convert a weighted optical signal into an electrical signal.

9. The apparatus of claim 8, said apparatus being configured to perform an integration function by summing up voltages generated by said opto-isolators connected in series.

10. The apparatus of claim 8, said apparatus being configured to perform an integration function by summing up currents generated by said opto-isolators connected in parallel.

11. The apparatus of claim 8, wherein said opto-isolators are resistive opto-isolators, and wherein said apparatus is configured to perform an integration function by measuring a total electrical resistance of said resistive opto-isolators connected in series.

12. The apparatus of claim 8, wherein said opto-isolators are capacitive opto-isolators, and wherein said apparatus is configured to perform an integration function by summing up capacitances of said capacitive opto-isolators connected in parallel.
